(19) United States
(12) Patent Application Publication
(10) Pub. No.: US 2022/0390294 A1
(43) Pub. Date: Dec. 8, 2022

(54) METHOD AND SYSTEM FOR MEASURING INTERFACIAL STRESS AND RESIDUAL STRESS IN MULTILAYER THIN FILMS COATED ON A SUBSTRATE

(71) Applicant: Feng Chia University, Taichung City (TW)

(72) Inventor: Chuen-Lin Tien, Taichung City (TW)

(21) Appl. No.: 17/736,783

(22) Filed: May 4, 2022

(30) Foreign Application Priority Data
Jun. 8, 2021 (TW) 110120838

(51) Int. Cl. G01L 1/00

(52) U.S. Cl. CPC G01L 1/005

(57) ABSTRACT

A method for measuring interfacial stress and residual stress in multilayer thin films coated on a substrate is disclosed. First of all, a residual stress measurement process is applied to each thin film of a multi-layered structure. Subsequently, after two kinds of interfacial stress (F_{HL}, F_{LH}) are calculated, a mathematical formula for estimating at least one adjusting parameter is derived based on the two interfacial stresses. As a result, a modified Ennos formula is obtained by involving the adjusting parameters into the Ennos formula, such that a residual stress in the multi-layered structure (i.e., multilayer thin films) is therefore calculated by using the modified Ennos formula.

### BACKGROUND OF THE INVENTION

### 1. Field of the Invention

The present invention relates to the technology field of thin film measurement, and more particularly to a method and system for measuring interfacial stress and residual stress in multilayer thin films coated on a substrate.

### 2. Description of the Prior Art

It is known that optical thin film, made of a dielectric material, is formed on a substrate or an optical component so as to perform a specific optical effect. The optical effect is transmitting light, reflecting light, absorbing light, scattering light, polarizing light, or changing phase. Nowadays, with the advanced development of optoelectronics technology as well as the widespread use of optical components and optoelectronic products, optical thin films have therefore got increasing attentions and applications. It is worth noting that there is certainly producing residual stress in an optical thin film during forming the optical thin film on a substrate, and the residual stress leads the optical thin film to be flexural deformation, thereby lowering the production yield and/or the reliability of the optical thin film.

Engineers skilled in thin film residual stress measurement certainly know that, substrate curvature is a useful and sensitive technique for measuring residual stress in a single-layered thin film. Therefore, the curvature measurement scheme is traditionally the most widely acknowledged method. The procedure of the curvature measurement method is to firstly measure the bow or curvature of a substrate coated with a thin film, and then utilizing a well-known Stoney formula to estimate the residual stress in the thin film. However, the Stoney formula is found not suitable for estimating the residual stress in multi-layered thin films. For example, the notch filter disclosed by China patent No. CN105116481B and the highly-reflective coating disclosed by Taiwan patent No. TW 1710458 both have a multi-layered structure.

Accordingly, numbers of methods for predicting residual stresses in multi-layered thin films have been proposed. For example, a simple formula for use in predicting residual stress in multi-layered thin films has been proposed by Ennos. The Ennos formula is expressed as follows:

$${σ}_{AVG} = \frac{{σ}_{f 1} \cdot {t}_{f 1} + {σ}_{f 2} \cdot {t}_{f 2} + {σ}_{f 3} \cdot {t}_{f 3} + … + {σ}_{fn} \cdot {t}_{fn}}{{t}_{f 1} + {t}_{f 2} + {t}_{f 3} + … + {t}_{f n}} \qquad ( a )$$

In the foregoing formula (a), σ_{AVG} represents the average residual stress in multi-layered thin films, σ_{fn} is the residual stress in a n-th layer of thin film, and t_{fn} means the thickness of the n-th layer of thin film. In other words, Ennos formula implies that the residual stress in multi-layered thin films can be obtained by weighting the average residual stress in each of the n number of single-layered thin films that are stacked to each other. Therefore, it is understood that Ennos formula is an ideal residual stress estimating formula not considering the interface stresses in multi-layered thin films.

It is worth mentioning that, literature 1 has reported that residual stresses are measured in Ag/Ni multilayer thin films from the substrate curvature and from lattice parameter measurements by x-ray diffraction, and the difference between the total multilayer film stress and the layer deposition stress can be attributed to a tensile interface stress of −2.27±0.67 J/m². Herein, literature 1 is written by Ruud et.al, and is entitled with “Bulk and interface stresses in silver-nickel multilayered thin films” so as to be published on Journal of Applied Physics, 74, 2517 (1993); doi: 10.1063/1.354692.

After fully reading the disclosures of China patent No. CN105116481B and Taiwan patent No. TW 1710458, it is clear that a multi-layered structure is fabricated by stacking a plurality of thin films together. Therefore, in case of there being a physical characteristics mismatch occurring in any two of the plurality of thin films, strains at the interface between the two thin films would rise, so as to lead at least one of the two thin films to be deformed or broken.

From above descriptions, it is known that there is still room for improvement in the Ennos formula (i.e., an ideal formula for estimating residual stress in multilayer thin films). In view of this fact, inventors of the present application have made great efforts to make inventive research and eventually provided a method and system for measuring interfacial stress and residual stress in multilayer thin films coated on a substrate.

### SUMMARY OF THE INVENTION

The primary objective of the present invention is to disclose a method for measuring interfacial stress and residual stress in multilayer thin films coated on a substrate. First of all, a residual stress measurement process is applied to each thin film of a multi-layered structure. Subsequently, after two kinds of interfacial stress (F_{HL}, F_{LH}) are calculated, a mathematical formula for estimating at least one adjusting parameter is derived based on the two interfacial stresses (F_{HL}, F_{LH}). As a result, a modified Ennos formula is obtained by involving the adjusting parameters into the Ennos formula, such that a residual stress in the multi-layered structure (i.e., multilayer thin films) is therefore calculated by using the modified Ennos formula.

For achieving the primary objective mentioned above, the present invention provides an embodiment of the method for measuring interfacial stress and residual stress in multilayer thin films coated on a substrate, comprising the steps of:

(1) applying, by a measurement apparatus, a residual stress measurement process to each of a plurality of thin films of the multi-layered structure, so as to correspondingly obtain a plurality of thin film residual stresses;

(2) calculating, by a computing device, a first interfacial stress and a second interfacial stress based on the plurality of thin film residual stresses, wherein there is said first interfacial stress or said second interfacial stress existing between any two of the multiple thin films;

(3) calculating, by configuring the computing device to execute a Ennos formula, a first value based on the plurality of thin film residual stresses and a plurality of thin film thickness values;

(4) generating, by the computing device, a second value based on the plurality of thin film thickness values, a stacking number of the plurality of thin films, the first interfacial stress, and the second interfacial stress; and

(5) calculating, by the computing device, a summation of the first value and the second value, thereby obtaining said residual stress in the multi-layered structure.

Moreover, the present invention also provides a system comprising a measurement apparatus and a computing device for measuring interfacial stress and residual stress in a multi-layered structure formed on a substrate The computing device comprises:

a memory storing an application program; and

a processor, being coupled to the memory;

wherein the application program includes instructions, such that in case the application program is executed, the processor being configured for:
applying, by controlling the measurement apparatus, a residual stress measurement process to each of a plurality of thin films of the multi-layered structure, so as to correspondingly obtain a plurality of thin film residual stresses;
calculating a first interfacial stress and a second interfacial stress based on the plurality of thin film residual stresses, wherein there is said first interfacial stress or said second interfacial stress existing between any two of the multiple thin films;
calculating, by execute a Ennos formula, a first value based on the plurality of thin film residual stresses and a plurality of thin film thickness values;
generating a second value based on the plurality of thin film thickness values, a stacking number of the plurality of thin films, the first interfacial stress, and the second interfacial stress; and
calculating a summation of the first value and the second value, thereby obtaining said residual stress in the multi-layered structure.

In one embodiment, the computing device is configured to execute a first mathematical formula and a second mathematical formula so as to calculate said first interfacial stress and said second interfacial stress, the first mathematical formula being F_{LH}=δ(F/w)_{HLH}−δ(F/w)_{HL}−δ(F/w)_{H}+F_{HS}, and the second mathematical formula being F_{HL}=δ(F/w)_{LHL}−δ(F/w)_{LH}−δ(F/w)_{L}+F_{LS};

wherein F_{HL} is an interfacial stress of one thin film having high refractive index deposited on one thin film having low refractive index, F_{LH} being an interfacial stress of one thin film having low refractive index deposited on one thin film having high refractive index, F_{HS} being an interfacial stress of one thin film having high refractive index deposited on said substrate, and F_{LS} being an interfacial stress of one thin film having low refractive index deposited on said substrate;

wherein δ(F/w)_{HLH} is an interface force per unit length of one sandwich structure consisting of one thin film having high refractive index, one thin film having low refractive index, and another one thin film having high refractive index;

wherein δ(F/w)_{LHL} is an interface force per unit length of one sandwich structure consisting of one thin film having low refractive index, one thin film having high refractive index, and another one thin film having low refractive index; and

wherein δ(F/w)_{HL} is an interface force per unit length of one thin film having high refractive index deposited on one thin film having low refractive index, and δ(F/w)_{HL} being an interface force per unit length of one thin film having low refractive index deposited on one high refractive index film.

In one embodiment, the thin film residual stress of one thin film having high refractive index is calculated by f_{H}=−δ(F/w)_{H}+F_{HS}, and the thin film residual stress of one thin film having low refractive index is calculated by f_{L}=−δ(F/w)_{L}+F_{LS}.

In one embodiment, said Ennos formula is as follows:

$${σ}_{V 1} = \frac{{σ}_{f 1} \cdot {t}_{f 1} + {σ}_{f 2} \cdot {t}_{f 2} + {σ}_{f 3} \cdot {t}_{f 3} + … + {σ}_{fn} \cdot {t}_{fn}}{{t}_{f 1} + {t}_{f 2} + {t}_{f 3} + … + {t}_{fn}} ;$$

wherein σ_{V1} is said first value, t_{fn} being the thin film thickness, and σ_{fn} being the thin film residual stress for the n-th layer.

In one embodiment, in case of the stacking number of the plurality of thin films is an odd, the computing device is configured to execute a third mathematical formula so as to calculate said second value, and the third mathematical formula is as follows:

$${σ}_{V 2} = \frac{( \frac{n - 1}{2} ) {F}_{HL} + ( \frac{n - 1}{2} ) {F}_{LH}}{2 ( {t}_{f 1} + {t}_{f 2} + {t}_{f 3} + … + {t}_{f n} )} ;$$

wherein σ_{V2} is said second value.

In one embodiment, in case of the stacking number of the plurality of thin films is an even, in the step (4) the computing device is configured to execute a fourth mathematical formula so as to calculate said second value, and the fourth mathematical formula is as follows:

$${σ}_{V 2} = \frac{( \frac{n}{2} ) {F}_{HL} + ( \frac{n - 2}{2} ) {F}_{LH}}{2 ( {t}_{f 1} + {t}_{f 2} + {t}_{f 3} + … + {t}_{fn} )} ;$$

wherein σ_{V2} is said second value.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a framework diagram of a system for measuring interfacial stress and residual stress in multilayer films according to the present invention;

FIG. 2 shows a flowchart of a method for measuring interfacial stress and residual stress in multilayer films according to the present invention;

FIG. 3 shows a first stereo diagram of an optoelectronic element having a multi-layered structure; and

FIG. 4 shows a second stereo diagram of the optoelectronic element.

### DETAILED DESCRIPTION OF THE PREFERRED EMBODIMENTS

To more clearly describe a method and system for measuring interfacial stress and residual stress in multilayer thin films coated on a substrate according to the present invention, related embodiments will be described in detail with reference to the attached drawings hereinafter.

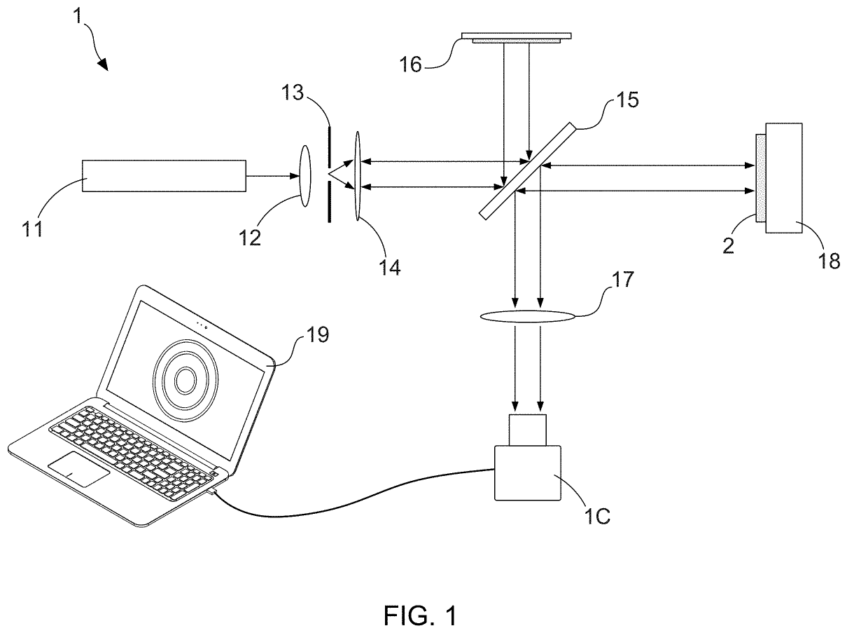

Engineers skilled in thin film residual stress measurement certainly know that, laser interferometric method is often utilized for measuring the residual stress in a thin film. Nowadays, Twyman-Green interferometer, one kind of laser interferometer, are conventionally arranged to be a thin film residual stress measurement system in combination with a computer. With reference to FIG. 1, there is shown a framework diagram of a system for measuring interfacial stress and residual stress in multilayer films according to the present invention. As FIG. 1 shows, the system 1 comprises a computing device 19 and a measurement apparatus, of which the measurement apparatus is a Twyman-Green interferometer consisting of a laser source 11, a microscope objective 12, a pinhole unit 13, a convex lens 14, a beam splitter 15, a reference plane 16, a screen 17, a platform 18, and a camera 1C.

Engineers skilled in thin film residual stress measurement must know that, for measuring the residual stress in a thin film coated on a substrate, it needs to operate the measurement apparatus to apply a residual stress measurement process to the thin film and the substrate, so as to obtain equal inclination interference image, surface contour map, curvature radius fitting curve in x-axis direction, and curvature radius fitting curve in y-axis direction, and consequently utilizing Stoney formula to estimate the residual stress in the thin film. However, the optoelectronic element 2 disposed on the platform 18 is a multi-layered film instead of a single-layered film, such that the Stoney formula is not suitable for estimating the residual stress in the multi-layered thin films of the optoelectronic element 2. Accordingly, numbers of methods for predicting residual stresses in multi-layered thin films have been proposed. For example, a simple formula for use in predicting residual stress in multi-layered thin films has been proposed by Ennos. As described in more detail below, Ennos formula implies that the residual stress in multi-layered thin films can be obtained by weighting the average residual stress in each of the n number of single-layered thin films that are stacked to each other. Therefore, it is understood that the Ennos formula is an ideal residual stress estimating formula not considering the interface stresses in multi-layered thin films. In other words, the Ennos formula is not allowed to correctly estimate the residual stress in multilayer thin films of the optoelectronic element 2.

Accordingly, a novel method for measuring interfacial stress and residual stress in multilayer thin films coated on a substrate is disclosed herein. First of all, the method utilizes a measurement apparatus to apply a residual stress measurement process is applied to each thin film of the multi-layered structure (i.e., the optoelectronic element 2). Subsequently, after two kinds of interfacial stress (F_{HL}, F_{LH}) are calculated, a mathematical formula for estimating at least one adjusting parameter is derived based on the two interfacial stresses (F_{HL}, F_{LH}). As a result, a modified Ennos formula is obtained by involving the adjusting parameters into the Ennos formula, such that a residual stress in the multilayer thin films of the optoelectronic element 2 is therefore calculated by using the modified Ennos formula.

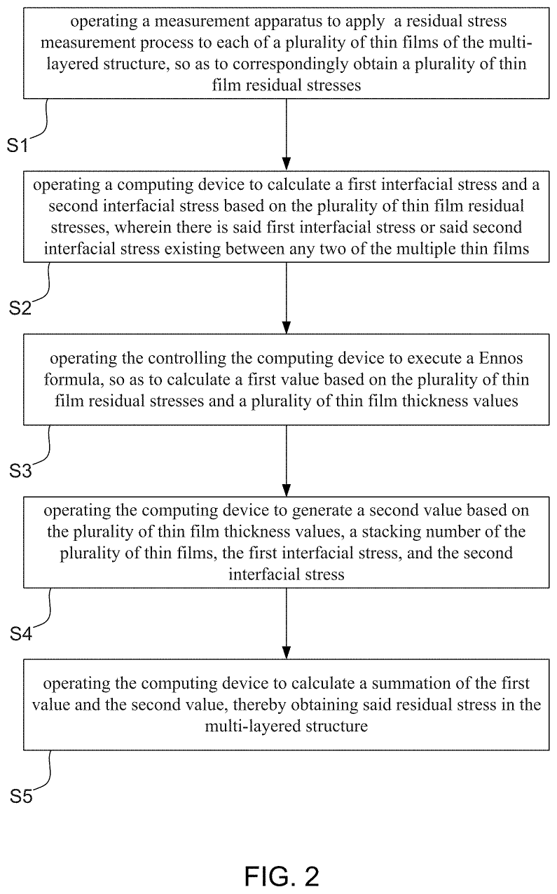

FIG. 2 shows a flowchart of a method for measuring interfacial stress and residual stress in multilayer films according to the present invention. As FIG. 2 shows, in step S1 a measurement apparatus is operated to apply a residual stress measurement process to each of a plurality of thin films of the optoelectronic element 2 having multi-layered structure, so as to correspondingly obtain each thin film's residual stresses. As explained in more detail below, in step S1, the measurement apparatus applies a residual stress measurement process to each thin film, so as to obtain equal inclination interference image, surface contour map, curvature radius fitting curve in x-axis direction, and curvature radius fitting curve in y-axis direction, and consequently utilizing Stoney formula to estimate the residual stress in the thin film.

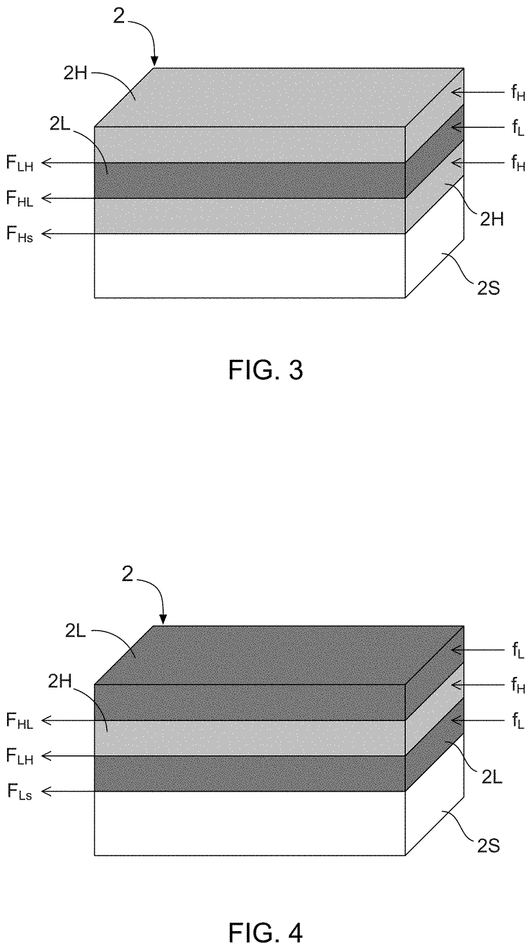

With reference to FIG. 3, there is shown a first stereo diagram of the optoelectronic element 2 having multi-layered structure. Moreover, FIG. 4 illustrates a second stereo diagram of the optoelectronic element 2. As FIG. 3 shows, the optoelectronic element 2 is allowed to be designed to comprise: a substrate 2S, one thin film 2H having high refractive index (“HRI thin film 2H”, hereinafter) formed on the substrate 2S, one thin film 2L having low refractive index (“LRI thin film 2L”, hereinafter) formed on the HRI thin film 2H, and another one HRI thin film 2H formed on the LRI thin film 2L. On the other hand, as FIG. 2 shows, the optoelectronic element 2 can also be designed to comprise: a substrate 2S, one LRI thin film 2L formed on the substrate 2S, one HRI thin film 2H formed on the LRI thin film 2L, and another one LRI thin film 2L formed on the HRI thin film 2H.

Therefore, in step S1, the measurement apparatus is utilized to apply a residual stress measurement process to each thin film after the thin film is fabricated. For example, after the HRI thin film 2H is deposited on the substrate 2S, the measurement apparatus is subsequently operated to apply the residual stress measurement process to the HRI thin film 2H coated on the substrate 2S. After that, the measurement apparatus is switched apply the residual stress measurement process to the LRI thin film 2L that is formed on the HRI thin film 2H, and so on until the multilayer thin films formed on the substrate 2S have all received the residual stress measurement. In FIG. 3 and FIG. 4, residual stress in the LRI thin film 2L is labeled as f_{L}, and residual stress in the HRI thin film 2H is labeled as f_{H}. It is worth noting that there are labels F_{HS}, F_{HL}, F_{LH}, and F_{LS} provided in FIG. 3 and FIG. 4, of which F_{HS} is an interfacial stress of the HRI thin film 2H deposited on the substrate 2S, F_{HL} is an interfacial stress of the HRI thin film 2H deposited on the LRI thin film 2L, F_{LH} being an interfacial stress of the LRI thin film 2L deposited on the HRI thin film 2H, and F_{LS} is an interfacial stress of the LRI thin film 2L deposited on the substrate 2S.

After completing the step S1, the method is subsequently proceeded to step S2, so as to configure the computing device 19 to calculate a first interfacial stress and a second interfacial stress (i.e., two kinds of interfacial stress existing in the multilayer thin films) based on the plurality of thin film residual stresses obtained in the step S1. According to FIG. 3 and FIG. 4, it is understood that there is said first interfacial stress or said second interfacial stress existing between any two of the multiple thin films (2H+2L+2H or 2L+2H+2L). According FIG. 3, interface force per unit length existing in the multilayer thin films can be calculated by utilizing following mathematical formulas (1)-(3). On the other hand, according FIG. 4, interface force per unit length existing in the multilayer films can be calculated by utilizing following mathematical formulas (4)-(6).

δ(F/w)_{H}=−f_{H}+F_{HS} (1)

δ(F/w)_{HL}=−f_{H}−f_{L}+F_{HL}+F_{HS} (2)

δ(F/w)_{HLH}=−2f_{H}−f_{L}+F_{HL}+F_{LH}+F_{HS} (3)

δ(F/w)_{L}=−f_{L}+F_{LS} (4)

δ(F/w)_{LH}=−f_{H}−f_{L}+F_{LH}+F_{LS} (5)

δ(F/w)_{LHL}=−f_{H}−2f_{L}+F_{HL}+F_{LH}+F_{LS} (6)

In the foregoing mathematical formulas (1)-(6), δ(F/w)_{HLH} is an interface force per unit length of one sandwich structure consisting of one HRI thin film 2H, one LRI thin film 2L and another one HRI thin film 2H. On the other hand, δ(F/w)_{LHL} is an interface force per unit length of one sandwich structure consisting of one LRI thin film 2L, one HRI thin film 2H and another one LRI thin film 2L. Moreover, δ(F/w)_{HL} is an interface force per unit length of one HRI thin film 2H deposited on one LRI thin film 2L, and δ(F/w)_{HL} is an interface force per unit length one LRI thin film 2L deposited on one HRI thin film 2H. In addition, δ(F/w)_{H} is an interface force per unit length one HRI thin film 2H deposited on the substrate 2S, and δ(F/w)_{L} is an interface force per unit length one LRI thin film 2L deposited on the substrate 2S.

Furthermore, a first mathematical formula can be derived based on the foregoing mathematical formulas (1)-(3), and is as follows. Similarly, a second mathematical formula can also be derived based on the foregoing mathematical formulas (4)-(6), and is as follows.

F_{LF}=δ(F/w)_{HLH}−δ(F/w)_{HL}−δ(f/w)_{H}+F_{HS} (7)

F_{HL}=δ(F/w)_{LHL}−δ(F/w)_{LH}−δ(F/w)_{L}+F_{LS} (8)

Therefore, in the step S2 the computing device 19 is configured to execute the first mathematical formula and the second mathematical formula so as to calculate said first interfacial stress and said second interfacial stress.

After completing the step S3, the method is subsequently proceeded to step S3, so as to configure the computing device 19 to execute a Ennos formula, thereby calculating a first value based on the plurality of thin film residual stresses and a plurality of thin film thickness values. The Ennos formula is expressed as follows:

$${σ}_{V 1} = \frac{{σ}_{f 1} \cdot {t}_{f 1} + {σ}_{f 2} \cdot {t}_{f 2} + {σ}_{f 3} \cdot {t}_{f 3} + … + {σ}_{f n} \cdot {t}_{fn}}{{t}_{f 1} + {t}_{f 2} + {t}_{f 3} + … + {t}_{fn}} \qquad ( 9 )$$

In the foregoing formula (9), σ_{V1} is said first value, σ_{fn} is the residual stress in a n-th layer of thin film, and t_{fn} means the thickness of the n-th layer of thin film. Subsequently, the method is proceeded to step S4. In the step S4, the computing device 19 is configured to generate a second value based on the plurality of thin film thickness values, a stacking number of the plurality of thin films, the first interfacial stress, and the second interfacial stress. Consequently, in step S5, the computing device 19 is configured to calculate a summation of the first value (i.e., σ^{V1}) and the second value (i.e., σ_{V2}), thereby obtaining said residual stress in the multilayer thin films (2H+2L+2H or 2L+2H+2L) formed on the substrate 2S.

Herein, it needs to particularly explain that, in case of the stacking number of the multilayer thin films is an odd, in the step S4 the computing device 19 is configured to execute a third mathematical formula so as to calculate said second value, and the third mathematical formula is as follows. On the other hand, in case of the stacking number of the plurality of thin films is an even, in the step S4 the computing device 19 is configured to execute a fourth mathematical formula so as to calculate said second value, and the fourth mathematical formula is as follows.

$${σ}_{V 2} = \frac{( \frac{n - 1}{2} ) {F}_{HL} + ( \frac{n - 1}{2} ) {F}_{LH}}{2 ( {t}_{f 1} + {t}_{f 2} + {t}_{f 3} + … + {t}_{fn} )} \qquad ( 10 )$$

$${σ}_{V 2} = \frac{( \frac{n}{2} ) {F}_{HL} + ( \frac{n - 2}{2} ) {F}_{LH}}{2 ( {t}_{f 1} + {t}_{f 2} + {t}_{f 3} + … + {t}_{fn} )} \qquad ( 11 )$$

Experimental Data

There is a need to repeat that, Ennos formula is an ideal residual stress estimating formula not considering the interface stresses in multi-layered thin films, such that Ennos formula is not allowed to correctly estimate the residual stress in multilayer thin films. Accordingly, a novel method for measuring interfacial stress and residual stress in multilayer thin films coated on a substrate is disclosed herein. First of all, the method utilizes a measurement apparatus to apply a residual stress measurement process is applied to each thin film of the multi-layered structure (i.e., the optoelectronic element 2). Subsequently, after two kinds of interfacial stress (F_{HL}, F_{LH}) are calculated, a mathematical formula for estimating at least one adjusting parameter is derived based on the two interfacial stresses (F_{HL}, F_{LH}). As a result, a modified Ennos formula is obtained by involving the adjusting parameters into the Ennos formula, such that a residual stress in the multilayer thin films of the optoelectronic element 2 is therefore calculated by using the modified Ennos formula.

As a result, related experimental data of 6 samples of the optoelectronic element 2 are integrated in following table (1).

TABLE 1

| | | | | Residual |
|---|---|---|---|---|
| | | | Residual | stress |
| | Thickness | | stress | estimating |
| | of | Measured | estimating | by Modified |
| | deposition | residual | by Ennos | Ennos |
| | film | stress | Formula | Formula |
| Samples | (nm) | (GPa) | (GPa) | (GPa) |
| SiO₂/B270 | 190 | −0.433 ± 0.023 | | |
| Ta₂O₅/SiO₂/ | 325 | −0.249 ± 0.007 | −0.396 | −0.370 |
| B270 | | | | |
| SiO₂/Ta₂O₅/ | 515 | −0.283 ± 0.003 | −0.409 | −0.310 |
| SiO₂/B270 | | | | |
| Ta₂O₅/B270 | 135 | −0.345 ± 0.024 | | |
| SiO₂/Ta₂O₅/ | 325 | −0.358 ± 0.008 | −0.396 | −0.370 |
| B270 | | | | |
| Ta₂O₅/SiO₂/ | 460 | −0.179 ± 0.005 | −0.381 | −0.271 |
| Ta₂O₅/B270 | | | | |

It needs to further explain that, SiO₂ is a material having low refractive index, and Ta₂O₅ is a material having high refractive index. In addition, B270 is one kind of glass for being as the substrate. Moreover, it is able to utilize the mathematical formula (7) to calculate F_{LH} between the SiO₂ thin film and the Ta₂O₅ thin film, and can also utilize the mathematical formula (8) to calculate F_{HL} between Ta₂O₅ thin film and the SiO₂ thin film. The calculated value of F_{LH} is 17.076 Nt/m, and the calculated value of F_{HL} is 83.690 Nt/m.

According to the table (1), it is known that the residual stress in multilayer thin films estimating by using Ennos formula is −0.381 GPa, and the residual stress in multilayer thin films estimating by using modified Ennos formula is −0.271 GPa. These results demonstrate there is an obvious difference between the residual stress estimating by using Ennos formula and the residual stress estimating by using modified Ennos formula.

Therefore, through the above descriptions, all embodiments of the method and system for measuring interfacial stress and residual stress in multilayer thin films coated on a substrate according to the present invention have been introduced completely and clearly. It is worth emphasizing that, the above description is made on embodiments of the present invention. However, the embodiments are not intended to limit the scope of the present invention, and all equivalent implementations or alterations within the spirit of the present invention still fall within the scope of the present invention.

What is claimed is:

1. A method for measuring interfacial stress and residual stress in a multi-layered thin film structure formed on a substrate, comprising the steps of:
(1) applying, by a measurement apparatus, a residual stress measurement process to each of a plurality of thin films of the multi-layered structure, so as to correspondingly obtain a plurality of thin film residual stresses;
(2) calculating, by a computing device, a first interfacial stress and a second interfacial stress based on the plurality of thin film residual stresses, wherein there is said first interfacial stress or said second interfacial stress existing between any two of the multiple thin films;
(3) calculating, by configuring the computing device to execute a Ennos formula, a first value based on the plurality of thin film residual stresses and a plurality of thin film thickness values;
(4) generating, by the computing device, a second value based on the plurality of thin film thickness values, a stacking number of the plurality of thin films, the first interfacial stress, and the second interfacial stress; and
(5) calculating, by the computing device, a summation of the first value and the second value, thereby obtaining said residual stress in the multi-layered thin film structure.

2. The method of claim 1, wherein in the step (2) the computing device being configured to execute a first mathematical formula and a second mathematical formula so as to calculate said first interfacial stress and said second interfacial stress, the first mathematical formula being F_{LH}=δ(F/w)_{HLH}−δ(F/w)_{HL}−δ(F/w)_{H}+F_{HS}, and the second mathematical formula being F_{HL}=δ(F/w)_{LHL}−δ(F/w)_{LH}−δ(F/w)_{L}+F_{LS};
wherein F_{HL} is an interfacial stress of one thin film having high refractive index deposited on one thin film having low refractive index, F_{LH} being an interfacial stress of one thin film having low refractive index deposited on one thin film having high refractive index, F_{HS} being an interfacial stress of one thin film having high refractive index deposited on said substrate, and F_{LS} being an interfacial stress of one thin film having low refractive index deposited on said substrate;
wherein δ(F/w)_{HLH} is an interface force per unit length of one sandwich structure consisting of one thin film having high refractive index, one thin film having low refractive index, and another one thin film having high refractive index;
wherein δ(F/w)_{LHL} is an interface force per unit length of one sandwich structure consisting of one thin film having low refractive index, one thin film having high refractive index, and another one thin film having low refractive index; and
wherein δ(F/w)_{HL} is an interface force per unit length of one thin film having high refractive index deposited on one thin film having low refractive index, and δ(F/w)_{HL} being an interface force per unit length of one thin film having low refractive index deposited on one high refractive index film.

3. The method of claim 2, wherein the thin film residual stress of one thin film having high refractive index is calculated by f_{H}=−δ(F/w)_{H}+F_{HS}, and the thin film residual stress of one thin film having low refractive index is calculated by f_{L}=−δ(F/w)_{L}+F_{LS}.

4. The method of claim 2, wherein said Ennos formula is as follows:
$${σ}_{V 1} = \frac{{σ}_{f 1} \cdot {t}_{f 1} + {σ}_{f 2} \cdot {t}_{f 2} + {σ}_{f 3} \cdot {t}_{f . 3} + … + {σ}_{fn} \cdot {t}_{fn}}{{t}_{f 1} + {t}_{f 2} + {t}_{f 3} + … + {t}_{fn}} ;$$
wherein σ_{V1} is said first value, t_{fn} being the thin film thickness, and σ_{fn} being the thin film residual stress for a n-th layer of thin film.

5. The method of claim 4, wherein in case of the stacking number of the plurality of thin films is an odd, in the step (4) the computing device is configured to execute a third mathematical formula so as to calculate said second value, and the third mathematical formula is as follows:
$${σ}_{V 2} = \frac{( \frac{n - 1}{2} ) {F}_{HL} + ( \frac{n - 1}{2} ) {F}_{LH}}{2 ( {t}_{f 1} + {t}_{f 2} + {t}_{f 3} + … + {t}_{f n} )} ;$$
wherein σ_{V2} is said second value.

6. The method of claim 4, wherein in case of the stacking number of the plurality of thin films is an even, in the step (4) the computing device is configured to execute a fourth mathematical formula so as to calculate said second value, and the fourth mathematical formula is as follows:
$${σ}_{V 2} = \frac{( \frac{n}{2} ) {F}_{HL} + ( \frac{n - 2}{2} ) {F}_{L H}}{2 ( {t}_{f 1} + {t}_{f 2} + {t}_{f 3} + … + {t}_{fn} )} ;$$
wherein σ_{V2} is said second value.

7. A system comprising a measurement apparatus and a computing device for measuring interfacial stress and residual stress in a multi-layered structure formed on a substrate, wherein the computing device comprises:
a memory storing an application program; and
a processor, being coupled to the memory;
wherein the application program includes instructions, such that in case the application program is executed, the processor being configured for:
applying, by controlling the measurement apparatus, a residual stress measurement process to each of a plurality of thin films of the multi-layered structure, so as to correspondingly obtain a plurality of thin film residual stresses;
calculating a first interfacial stress and a second interfacial stress based on the plurality of thin film residual stresses, wherein there is said first interfacial stress or said second interfacial stress existing between any two of the multiple thin films;
calculating, by execute a Ennos formula, a first value based on the plurality of thin film residual stresses and a plurality of thin film thickness values;
generating a second value based on the plurality of thin film thickness values, a stacking number of the plurality of thin films, the first interfacial stress, and the second interfacial stress; and
calculating a summation of the first value and the second value, thereby obtaining said residual stress in the multi-layered structure.

8. The system of claim 7, wherein the processor executes a first mathematical formula and a second mathematical formula so as to calculate said first interfacial stress and said second interfacial stress, the first mathematical formula being F_{LH}=δ(F/w)_{HLH}−δ(F/w)_{HL}−δ(F/w)_{H}+F_{HS}, and the second mathematical formula being F_{HL}=δ(F/w)_{LHL}−δ(F/w)_{LH}−δ(F/w)_{L}+F_{LS};
wherein F_{HL} is an interfacial stress of one thin film having high refractive index deposited on one thin film having low refractive index, F_{LH} being an interfacial stress of one thin film having low refractive index deposited on one thin film having high refractive index, F_{HS} being an interfacial stress of one thin film having high refractive index deposited on said substrate, and F_{LS} being an interfacial stress of one thin film having low refractive index deposited on said substrate;
wherein δ(F/w)_{HLH} is an interface force per unit length of one sandwich structure consisting of one thin film having high refractive index, one thin film having low refractive index, and another one thin film having high refractive index;
wherein δ(F/w)_{LHL} is an interface force per unit length of one sandwich structure consisting of one thin film having low refractive index, one thin film having high refractive index, and another one thin film having low refractive index; and
wherein δ(F/w)_{HL} is an interface force per unit length of one thin film having high refractive index deposited on one thin film having low refractive index, and δ(F/w)_{HL} being an interface force per unit length of one thin film having low refractive index deposited on one high refractive index film.

9. The system of claim 8, wherein the thin film residual stress of one thin film having high refractive index is calculated by f_{H}=−δ(F/w)_{H}+F_{HS}, and the thin film residual stress of one thin film having low refractive index is calculated by f_{L}=−δ(F/w)_{L}+F_{LS}.

10. The system of claim 8, wherein said Ennos formula is as follows:
$${σ}_{V 1} = \frac{{σ}_{f 1} \cdot {t}_{f 1} + {σ}_{f 2} \cdot {t}_{f 2} + {σ}_{f 3} \cdot {t}_{f 3} + … + {σ}_{fn} \cdot {t}_{fn}}{{t}_{f 1} + {t}_{f 2} + {t}_{f 3} + … + {t}_{fn}} ;$$
wherein σ_{V1} is said first value, t_{fn} being the thin film thickness, and σ_{fn} being the thin film residual stress for a n-th layer of thin film.

11. The system of claim 10, wherein in case of the stacking number of the plurality of thin films is an odd, the processor executes a third mathematical formula so as to calculate said second value, and the third mathematical formula is as follows:
$${σ}_{V 2} = \frac{( \frac{n - 1}{2} ) {F}_{HL} + ( \frac{n - 1}{2} ) {F}_{LH}}{2 ( {t}_{f 1} + {t}_{f 2} + {t}_{f 3} + … + {t}_{fn} )} ;$$
wherein σ_{V2} is said second value.

12. The system of claim 10, wherein in case of the stacking number of the plurality of thin films is an even, the processor execute a fourth mathematical formula so as to calculate said second value, and the fourth mathematical formula is as follows:
$${σ}_{V 2} = \frac{( \frac{n}{2} ) {F}_{HL} + ( \frac{n - 2}{2} ) {F}_{LH}}{2 ( {t}_{f 1} + {t}_{f 2} + {t}_{f 3} + … + {t}_{fn} )} ;$$
wherein σ_{V2} is said second value.
